(19) United States
(12) Patent Application Publication
(10) Pub. No.: US 2006/0060654 A1
(43) Pub. Date: Mar. 23, 2006

(54) Method of decoding barcode symbols and the like using multiple scanning lines

(76) Inventors: Kazukuni Hosoi, Saitama Pref. (JP); Haruo Matsuoka, Saitama Pref. (JP)

Correspondence Address: KAPLAN GILMAN GIBSON & DERNIER L.L.P., 900 ROUTE 9 NORTH, WOODBRIDGE, NJ, 07095, US

(21) Appl. No.: 10/948,108

(22) Filed: Sep. 23, 2004

(51) Int. Cl. G06K 7/10

(52) U.S. Cl. 235/462.12; 235/462.08

(57) ABSTRACT

The present invention provides a method of encoding a barcode, in which the barcode is scanned at multiple scanning lines along plural length portions to determine potential locations where the bars probably exist. For each potential length, data obtained at all the scanning lines is synthesized to determine the validity of the location. The plural length portions are then combined to ascertain the information.

### FIELD OF THE INVENTION

This invention relates to techniques of decoding barcodes, and more particularly, to a method of decoding a 1-D barcode in which the barcode is scanned at multiple scanning lines so as to read and decode barcodes of low quality, poor readability and/or having one or more defects by potentially using information from different horizontal portions of different scan lines to piece the together the equivalent of a single scan line.

### BACKGROUND OF THE INVENTION

1-D barcodes are universally used to provide information in a machine-readable format, such as the well-known Universal Product Code (UPC) strip on a product package. A 1-D barcode is usually formed by bars and spaces arranged in parallel along a length of the barcode, and the encoded information is represented by the arrangement of the bars and the spaces, and in particular, by the locations along the length of the barcode where the bars exist. To read the barcode, the varying widths of the bars, and the spaces between the bars, are measured and interpreted to extract the data.

However, the barcode is difficult to correctly read when the barcode is defective or not clear. For example, as shown in FIG. 1(a), if a defect in the form of a tilted line 11 runs across the bars 1, the point 12 where the tilted line 11 meets with the scanning line 2 may be improperly taken by the scanner as a location where a bar exists. In FIG. 2(a), some of the bars 1a in the barcode 10 are broken or are not clear enough, and will be erroneously read as spaces by the scanner if the scanning line 2 runs through the missing or unclear portions of the defective bars 1a. Additionally, if the barcode is beneath an uneven transparent covering material such as a plastic wrapper, the barcode may not be correctly read.

Therefore, there exists a need to improve the reliability in reading a barcode, especially when the barcode is defective or has poor readability.

### SUMMARY OF THE INVENTION

The present invention provides a method of encoding a barcode in which the barcode is scanned along multiple scanning lines along a length of the barcode to determine potential locations where the bars probably exist. For each potential location, data obtained at all the scanning lines are analyzed in combination to determine the validity of the location. Thus, the defective barcode with poor readability can still be correctly read since most of the scanning lines may run across the good portions of the defective bars.

In a preferred embodiment, the barcode is scanned by an image area reader or area scanner. Preferably, there are at least three scanning lines, and for each potential location found by the scanning, the majority of the data obtained at all the scanning lines determines the data. Then, the determination at each location is used in combination with the determination at other locations to fully decode the information. In other enhanced embodiments, other combinations in addition to a “majority rules” decision may be utilized.

### DESCRIPTION OF THE DRAWINGS

The above and other advantages and features of the present invention will be clearer after reading the detailed description of preferred embodiments of the present invention with reference to the accompanying drawings in which:

FIGS. 1(a) and 1(b) illustrate the problems existing with the conventional methods in reading defective barcode symbols; and

FIGS. 2(a) and 2(b) illustrate that the method of the present invention solves the problems in FIGS. 1(a) and 1(b).

### DETAILED DESCRIPTION OF PREFERRED EMBODIMENTS

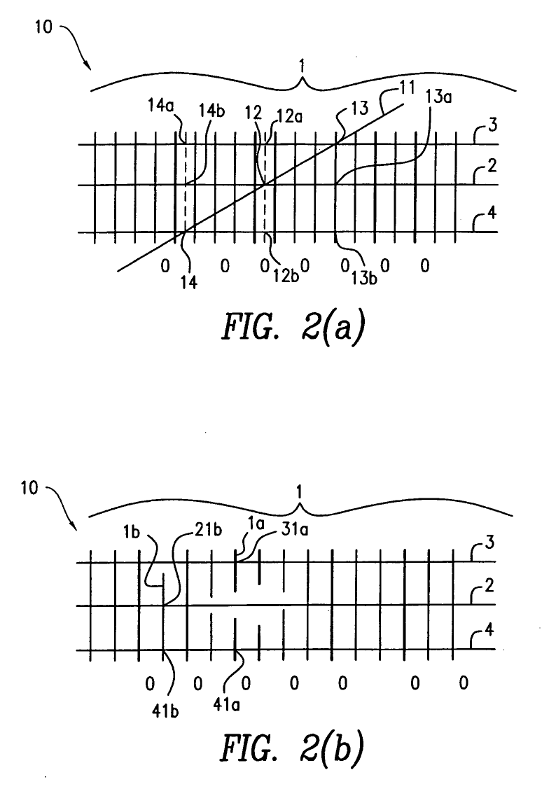

According to the present invention, the barcode is scanned along multiple scanning lines instead of using only one single scanning line in the conventional method. Preferably, the scanning lines are generally parallel to each other. In an embodiment as illustrated in FIGS. 2(a) and 2(b), the barcode 10 is scanned along three scanning lines 2, 3 and 4. Obviously, more scanning lines can be used to increase the reliability. This can be done by means of an image area reader or area scanner. The barcode 10 can be scanned at the multiple scanning lines 2,3, 4 simultaneously or can be scanned line by line.

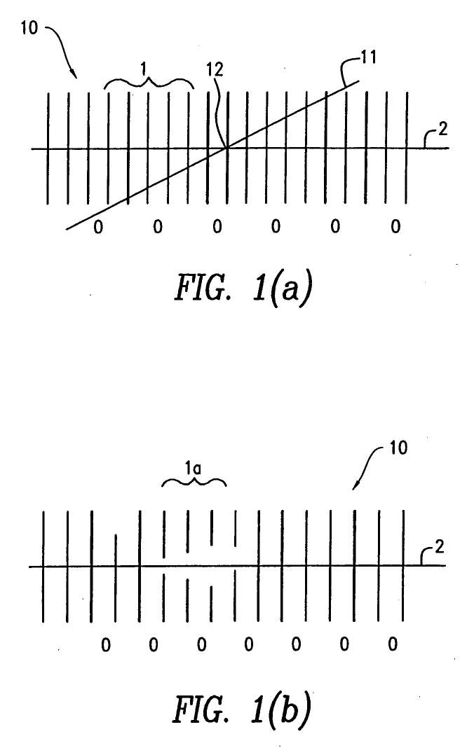

As shown in FIG. 2(a), which corresponds to FIG. 1(a) where a tilted line 11 runs across the barcode 10, with the three scanning lines 2, 3 and 4 used according to the present invention, the tilted line 11 meets with the scanning lines 2, 3 and 4 at points 12, 13 and 14 respectively. Thus, from the reading result of the scanning, a bar may exist at each of the locations corresponding to points 12, 13 and 14, which would be a final conclusion in the prior art if only a single scanning line is used.

However, according to the method of the present invention, for each of the above potential locations determined by the points 12, 13 and 14, the data obtained in all the three scanning lines 2, 3 and 4 are combined to determine the actual presence of the bars at these locations according to a predetermined technique. In a preferred embodiment, majority decision rule is adopted to ascertain the information at the location. More specifically, with respect to a specific location, if the majority of the scanning lines indicate that there is a bar, the location is determined to contain a bar, while if more scanning lines indicate that there is no bar, the location is determined to not contain a bar.

For example, as to the location corresponding to point 12, the data obtained at scanning lines 3 and 4 shows that there is no bar found at points 12a and 12b corresponding to the location. Similarly, as to the location corresponding to point 14, the data obtained at the scanning lines 2 and 3 indicates that there is no bar at corresponding points 14a and 14b. According to the majority decision rule, the locations corresponding to points 12 and 14 are determined invalid and there is no bar running across the points 12 and 14.

As to point 13 where the scanning line 13 happens to meet with a bar 1, the data obtained at other two scanning lines 2 and 4 also indicates that a bar may exist at the location corresponding to the point 13. Thus, the location corresponding to point 13 is validated, and there is a bar existing at the location corresponding to point 13 and running through point 13. For all other bars 1, the data read at all three scanning lines 2, 3 and 4 is the same, and the locations where the bars 1 exist can be thus determined. When scanning is complete, the information can be compiled from piecing together the information gathered at each location using the foregoing technique. After all the locations are determined, the barcode is decoded according to the techniques well-known in the art.

It is also notable that other techniques of combining the plural scanning lines in addition to a “majority rules” decision may be utilized. For example, the system could require that at least four out of five show the presence of the bar. Or, the system could combine the light levels received when reading all of the bars and determine the presence of a bar if and when the combined signals from all the scanning lines exceed a predetermined threshold. Therefore, with the teaching of the present invention, the tilted line 11 or other imperfections do not result in an incorrect interpretation of the data.

FIG. 2(b) illustrates the situation similar to FIG. 1(b) where some of the bars are not clear or are partially missing. For example, the middle portion of bar 1a is missing, and the scanning line 2 runs through the missing middle portion of bar 1a. In the prior art as shown in FIG. 1(b), bar 1a will be found not existing. However, according to the teachings of the present invention, two other scanning lines 3 and 4 run across the good portions of bar 1a, and the data obtained at the meeting points 31a and 41a indicates that there may exist a bar at the location corresponding to the points 31a and 41a. Even though the data read at scanning line 2 shows that there is no bar existing at such location, according to the majority decision rule, the location is deemed to contain a valid bar since more scanning lines show that there is a bar at the location.

Similarly, defective bar 1b can be determined to be there from the data obtained at the scanning lines 2 and 4 even though the scanning line 3 does not detect bar 1b. Thus, the location corresponding to the meeting points 21b and 41b is validated by the fact that more scanning lines (2 and 4) show that there is a bar.

Though the preferred embodiments of the invention have been described above in detail, it is understood that adaptations and modifications are possible to a person of ordinary skill in the art without departing from the spirit and scope of the invention. For example, the 1-D barcode may be a constituent part of a stacked barcode, and a variety of one and two dimensional barcodes may be utilized. Instead of the majority decision rule, an average calculation of the data obtained at a specific location by all the scanning lines may be used. Thus, the scope of the present invention is solely defined by the accompanying claims.

What is claimed is:

1. A method of reading a barcode formed by parallel bars and spaces, comprising the steps of:
scanning, at different scanning lines, along a length of said barcode, to determine potential locations along said length where said bars probably exist;
for each length scanned, combining data obtained by said scanning at all of said different scanning lines to detect data, and combing the data detected along each length with data detected along other lengths of said bar to obtain complete data.

2. The method of claim 1, wherein said different scanning lines are parallel to each other.

3. The method of claim 2, wherein said barcode is scanned at said different scanning lines simultaneously.

4. The method of claim 2, wherein said barcode is scanned by an image area sensor or area scanner.

5. The method of claim 2, wherein said barcode is scanned along said scanning lines line by line.

6. The method of claim 1, wherein said potential location is determined to be valid when a majority of said data obtained at all said different scanning lines shows that a bar exists.

7. The method of claim 6, wherein said barcode is scanned at three or more different scanning lines.

8. The method of claim 1, wherein said potential location is determined to be valid when an average of said data obtained at all said different scanning lines shows that a bar exists.

9. The method of claim 1, wherein said barcode is a 1-D barcode.

10. The method of claim 9, wherein said 1-D barcode is a constituent element of a multi dimensional barcode.

11. A method of decoding a barcode, comprising the steps of:
scanning said barcode along multiple scanning lines and along predetermined lengths to obtain data at all said multiple scanning lines along said length;
ascertaining data along each of said lengths by combining information from plural lines;
for each of said potential lengths, using said data obtained from all said multiple scanning lines and associated to said each location to verify said each location in accordance with a predetermined scheme; and
decoding said barcode by combining data from plural lengths.

12. The method of claim 11, wherein said scanning is carried out by an image area reader or area scanner.

13. The method of claim 11, wherein there are at least three said scanning lines.

14. The method of claim 13, wherein said predetermined scheme is such that, for said each length portion, a majority of said data obtained from all said scanning lines is utilized to determine the data.

15. The method of claim 11, wherein each of said potential locations is determined if said data in said each location obtained at any of said multiple scanning lines shows that said character of said barcode exists.
